(19) United States
(12) Patent Application Publication
(10) Pub. No.: US 2016/0236685 A1
(43) Pub. Date: Aug. 18, 2016

(54) VEHICLE CONTROL APPARATUS, VEHICLE CONTROL SYSTEM, AND VEHICLE CONTROL METHOD

(71) Applicant: FUJITSU TEN LIMITED, Kobe-shi (JP)

(72) Inventors: Tomohito INOUE, Kobe-shi (JP); Kohichi TOMIYAMA, Kobe-shi (JP)

(73) Assignee: FUJITSU TEN LIMITED, Kobe-shi (JP)

(21) Appl. No.: 15/010,266

(22) Filed: Jan. 29, 2016

(30) Foreign Application Priority Data
Feb. 16, 2015 (JP) 2015-027255

(51) Int. Cl. B60W 30/165; G01S 13/06; G01S 13/93

(52) U.S. Cl. CPC B60W 30/165; G01S 13/931; G01S 13/06; G01S 2013/9325

(57) ABSTRACT

A vehicle control apparatus for performing control such that a vehicle follows a preceding vehicle, includes: a calculating unit that calculates a target time for an inter-vehicle distance deviation which is obtained by subtracting a target inter-vehicle distance from a measurement value of the inter-vehicle distance between the vehicle and the preceding vehicle to be substantially 0; a correction unit that calculates a correction deceleration larger than a target deceleration in a case where the inter-vehicle distance deviation provides a deviation corresponding to a position of the vehicle closer to the preceding vehicle than a position where the inter-vehicle distance deviation is substantially 0; and a control unit that controls a deceleration of the vehicle at a deceleration jerk according to a magnitude of the correction deceleration such that, when the target time comes, the inter-vehicle distance deviation is substantially 0.

### CROSS-REFERENCE TO RELATED APPLICATIONS

This application is based on and claims priority under 35 USC 119 from Japanese Patent Application No. 2015-027255 filed on Feb. 16, 2015, the entire disclosure of which is incorporated herein by reference.

### BACKGROUND

1. Technical Field

The present invention relates to control on a vehicle with respect to a target to be followed.

2. Related Art

There is a vehicle control system for performing control such that a vehicle follows a preceding vehicle while accelerating or decelerating. This vehicle control system is composed of, for example, a vehicle control apparatus mounted on the vehicle and various sensors such as a radar device. The vehicle control apparatus acquires position information such as the distance of the preceding vehicle from the vehicle and the angle of the preceding vehicle, and speed information such as the relative speed of the preceding vehicle to the vehicle, from the radar device, and controls the throttle and brake of the vehicle such that an inter-vehicle distance deviation is about 0 (zero) m. The inter-vehicle distance deviation is a value which is obtained by subtracting a target inter-vehicle distance which is a target value of the inter-vehicle distance between the vehicle and the preceding vehicle from a measurement value of the inter-vehicle distance.

As described above, the vehicle control apparatus automatically controls at least one of the acceleration and deceleration of the vehicle such that the vehicle travels while keeping the target inter-vehicle distance between the vehicle and the preceding vehicle, thereby supporting driving of a user (for example, a driver) of the vehicle. Hereinafter, at least one of acceleration and deceleration of the vehicle will be defined as acceleration/deceleration, and a description will be made. Also, as an explanatory material on a technology related to the present invention, there is JP-A-2002-036908.

### SUMMARY OF INVENTION

By the way, the vehicle control apparatus automatically controls acceleration/deceleration of the traveling speed of the vehicle on the assumption that the preceding vehicle travels at a constant speed. For this reason, in a case where the preceding vehicle decelerates rapidly, the inter-vehicle distance deviation of the vehicle and the preceding vehicle increases instantaneously. As a result, the inter-vehicle distance deviation provides a deviation corresponding to a position of the vehicle closer to the preceding vehicle than a position where the inter-vehicle distance deviation is substantially 0. In this case where the distance between the vehicle and the preceding vehicle is too shorter than the target inter-vehicle distance, in order to prevent the vehicle from getting closer to the preceding vehicle, the vehicle control apparatus increases the deceleration of the vehicle. As a result, the vehicle decelerates rapidly, and it may be impossible to appropriately perform control on acceleration and deceleration of the vehicle.

At least one embodiment of the present invention is to appropriately perform control deceleration of a vehicle even if a preceding vehicle decelerates rapidly when the vehicle follows the preceding vehicle.

[1] The at least one embodiment of the present invention provides a vehicle control apparatus for performing control such that a vehicle follows a preceding vehicle, including: a calculating unit that calculates a target time for an inter-vehicle distance deviation which is obtained by subtracting a target inter-vehicle distance from a measurement value of the inter-vehicle distance between the vehicle and the preceding vehicle to be substantially 0; a correction unit that calculates a correction deceleration larger than a target deceleration in a case where the inter-vehicle distance deviation provides a deviation corresponding to a position of the vehicle closer to the preceding vehicle than a position where the inter-vehicle distance deviation is substantially 0; and a control unit that controls a deceleration of the vehicle at a deceleration jerk according to a magnitude of the correction deceleration such that, when the target time comes, the inter-vehicle distance deviation is substantially 0.

[2] It may be the vehicle control apparatus according to [1], in which: in a case where the inter-vehicle distance deviation provides a first deviation corresponding to the position of the vehicle closer to the preceding vehicle than the position where the inter-vehicle distance deviation is substantially 0, the correction unit calculates a first correction deceleration larger than the target deceleration, and the control unit controls the deceleration of the vehicle at a deceleration jerk according to the first correction deceleration and larger than a deceleration jerk according to the target deceleration, such that, when the target time comes, the inter-vehicle distance deviation is substantially 0.

[3] It may be the vehicle control apparatus according to [2], in which: in a case where the inter-vehicle distance deviation provides a second deviation corresponding to the position of the vehicle closer to the preceding vehicle than the position where the inter-vehicle distance deviation is substantially 0 and corresponding to a position of the vehicle farther from the preceding vehicle than a position where the first deviation is obtained, the correction unit calculates a second correction deceleration smaller than the first correction deceleration, and the control unit controls the deceleration of the vehicle at a deceleration jerk according to the second correction deceleration and smaller than the deceleration jerk according to the first target deceleration, such that, when the target time comes, the inter-vehicle distance deviation is substantially 0.

[4] It may be the vehicle control apparatus according to any one of [1] to 3, further including: an acquiring unit that acquires information on a driving torque to drive the vehicle in a traveling direction, in which the control unit controls the deceleration of the vehicle such that, in a case where the vehicle automatically stops without any operation of a driver, braking torque to brake the vehicle exceeds the driving torque.

[5] It may be the vehicle control apparatus according to any one of [1] to 3, further including: a storage unit that stores a driving torque of the vehicle immediately before stopping, in which the control unit controls the deceleration of the vehicle such that, in a case where the vehicle automatically stops without any operation of a driver, braking torque to decelerate the vehicle exceeds the driving torque of the vehicle immediately before stopping.

[6] The at least one embodiment of the present invention provides a vehicle control system including: a radar device that detects target information on a position of a preceding vehicle and relative speed to the preceding vehicle; and a vehicle control apparatus including: a calculating unit that calculates a target time for an inter-vehicle distance deviation which is obtained by subtracting a target inter-vehicle distance from a measurement value of the inter-vehicle distance between the vehicle and the preceding vehicle to be substantially 0; a correction unit that calculates a correction deceleration larger than a target deceleration in a case where the inter-vehicle distance deviation provides a deviation corresponding to a position of the vehicle closer to the preceding vehicle than a position where the inter-vehicle distance deviation is substantially 0; and a control unit that controls the deceleration of the vehicle at a deceleration jerk according to the magnitude of the correction deceleration such that, when the target time comes, the inter-vehicle distance deviation is substantially 0.

[7] The at least one embodiment of the present invention provides a vehicle control method of performing control such that a vehicle follows a preceding vehicle, including: calculating a target time for an inter-vehicle distance deviation which is obtained by subtracting a target inter-vehicle distance from a measurement value of the inter-vehicle distance between the vehicle and the preceding vehicle to be substantially 0; calculating a correction deceleration larger than a target deceleration in a case where the inter-vehicle distance deviation provides a deviation corresponding to a position of the vehicle closer to the preceding vehicle than a position where the inter-vehicle distance deviation is substantially 0; and controlling the deceleration of the vehicle at a deceleration jerk according to the magnitude of the correction deceleration such that, when the target time comes, the inter-vehicle distance deviation is substantially 0.

[8] The at least one embodiment of the present invention provides a vehicle control apparatus for performing control such that a vehicle follows a preceding vehicle, including: an acquiring unit that acquires information on a driving torque to drive the vehicle in a traveling direction; and a control unit that controls the deceleration of the vehicle such that, in a case where the vehicle automatically stops without any operation of a driver of the vehicle, braking torque to brake the vehicle exceeds the driving torque.

According to the at least one embodiment of the present invention, since the vehicle control apparatus controls the deceleration of the vehicle at a deceleration jerk according to the magnitude of a correction deceleration, it is possible to perform control such that the vehicle decelerates appropriately while preventing occurrence of factors such as swing back which inhibit the comfort of the user of the vehicle.

Also, according to the at least one embodiment of the present invention, since the vehicle control unit calculates an update deceleration, and decelerates the vehicle such that the magnitude of the braking torque exceeds the magnitude of the driving torque, there is no possibility that the user would feel a risk of collision of the vehicle with a preceding vehicle, and it is possible to ensure the safety of the user of the vehicle.

### BRIEF DESCRIPTION OF DRAWINGS

FIG. 1 is a view for explaining a state where a vehicle follows a preceding vehicle.

FIG. 2 is a view for explaining the configuration of a vehicle control system.

FIG. 3 is a flow chart illustrating processes of a control unit.

FIG. 4 is a flow chart illustrating a correction determination process.

FIG. 5 is a view illustrating transitions of the speed and deceleration of the vehicle over time.

FIG. 6 is another view illustrating transitions of the speed and deceleration of the vehicle over time.

FIG. 7 is a view for explaining the relation between the driving torque and braking torque of the vehicle immediately before stopping.

FIG. 8 is a flow chart illustrating a torque determination process.

Hereinafter, an embodiment of the present invention will be described with reference to the accompanying drawings. Here, the outline of a vehicle control method according to the embodiment will be first described, and then a vehicle control apparatus using the vehicle control method according to the embodiment will be described.

### DESCRIPTION OF EMBODIMENTS

### First Embodiment

### 1. Outline of Vehicle Control Method

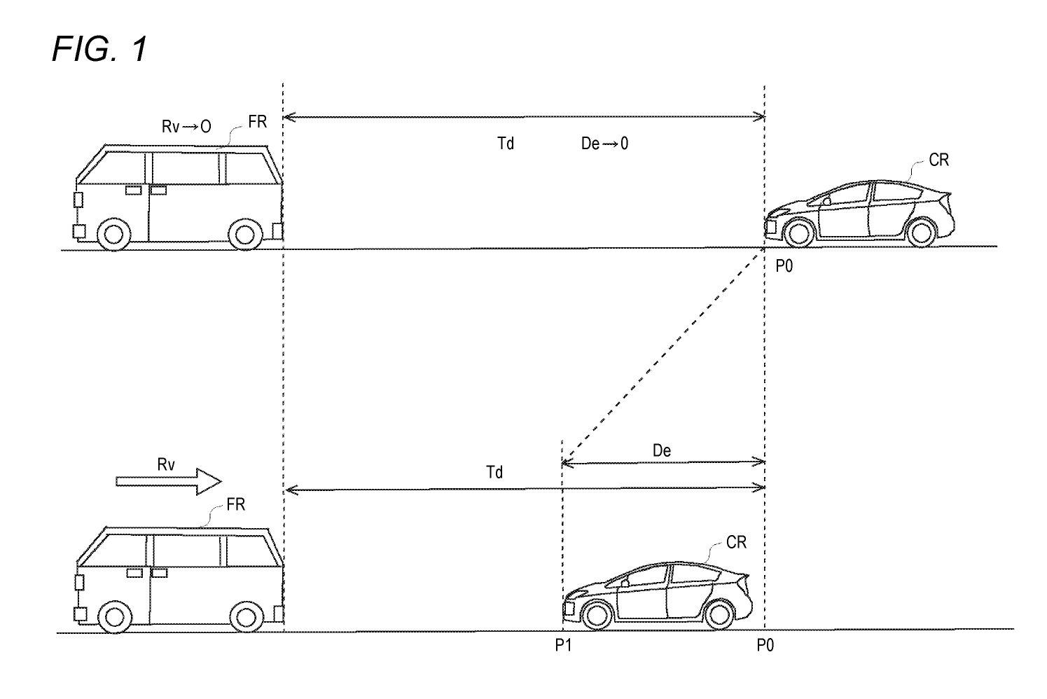

FIG. 1 is a view for explaining a state where a vehicle CR follows a preceding vehicle FR. A vehicle control apparatus mounted on the vehicle CR performs control such that the vehicle CR travels along the preceding vehicle FR while maintaining a target inter-vehicle distance Td. Specifically, when the vehicle CR travels, the vehicle control apparatus controls the throttle and brake of the vehicle CR, thereby controlling at least one of acceleration and deceleration (acceleration/deceleration) of the vehicle. The configuration and functions of the vehicle control apparatus will be described below. Also, the target inter-vehicle distance Td is an ideal inter-vehicle distance between the vehicle CR and the preceding vehicle FR. As for the target inter-vehicle distance, a user of the vehicle CR sets it by using a display unit or the like installed inside the vehicle, or the vehicle control apparatus sets it on the basis of the speed of the vehicle. The target inter-vehicle distance is, for example, 80 m.

Then, the vehicle control apparatus subtracts the target inter-vehicle distance Td from an actual inter-vehicle distance which is a measurement value of the inter-vehicle distance between the vehicle CR and the preceding vehicle FR, thereby obtaining the difference value therebetween as an inter-vehicle distance deviation De. An actual inter-vehicle distance and relative speed Rv are detected by a radar device to be described below. The vehicle control apparatus acquires the actual inter-vehicle distance and relative speed Rv of the preceding vehicle FR from the radar device.

In a case where a measurement value of the inter-vehicle distance between the vehicle CR and the preceding vehicle FR is substantially the same as the target inter-vehicle distance, the inter-vehicle distance deviation De is substantially 0 (zero) m. For example, in a case where the position of the vehicle CR relative to the position of the preceding vehicle FR provides a reference position P0 as shown in the upper part of FIG. 1, the inter-vehicle distance deviation De is substantially 0 m. Meanwhile, in a case where the position of the vehicle CR relative to the position of the preceding vehicle FR moves from the reference position P0 to a proximity position P1 closer to the preceding vehicle FR, the inter-vehicle distance deviation De becomes negative. Also, in a case where the position of the vehicle CR relative to the position of the preceding vehicle FR moves from the reference position P0 to a position farther from the preceding vehicle FR, the inter-vehicle distance deviation De becomes positive.

The relative speed Rv is the speed of the preceding vehicle FR as seen from the vehicle CR. In a case where the speed of the preceding vehicle FR is higher than the speed of the vehicle CR (hereinafter, referred to as the vehicle speed), the relative speed Rv provides a positive value. Meanwhile, in a case where the speed of the preceding vehicle FR is lower than the vehicle speed, the relative speed Rv provides a negative value. Also, an arrow of FIG. 1 representing the relative speed Rv and directed to the right represents that the relative speed Rv is a negative value. In other words, the arrow of FIG. 1 represents that the preceding vehicle FR is getting closer to the vehicle CR.

The vehicle control apparatus calculates a target control time, using the inter-vehicle distance deviation De and the relative speed Rv. The target control time is an ideal time for the vehicle control apparatus to control the deceleration of the vehicle CR such that the inter-vehicle distance deviation De of the vehicle CR and the preceding vehicle FR is substantially 0. The vehicle control apparatus controls deceleration of the vehicle CR such that, when the target control time (hereinafter, referred to as the “target time”) comes, the inter-vehicle distance deviation De is substantially 0.

### 2. Block Diagram of System

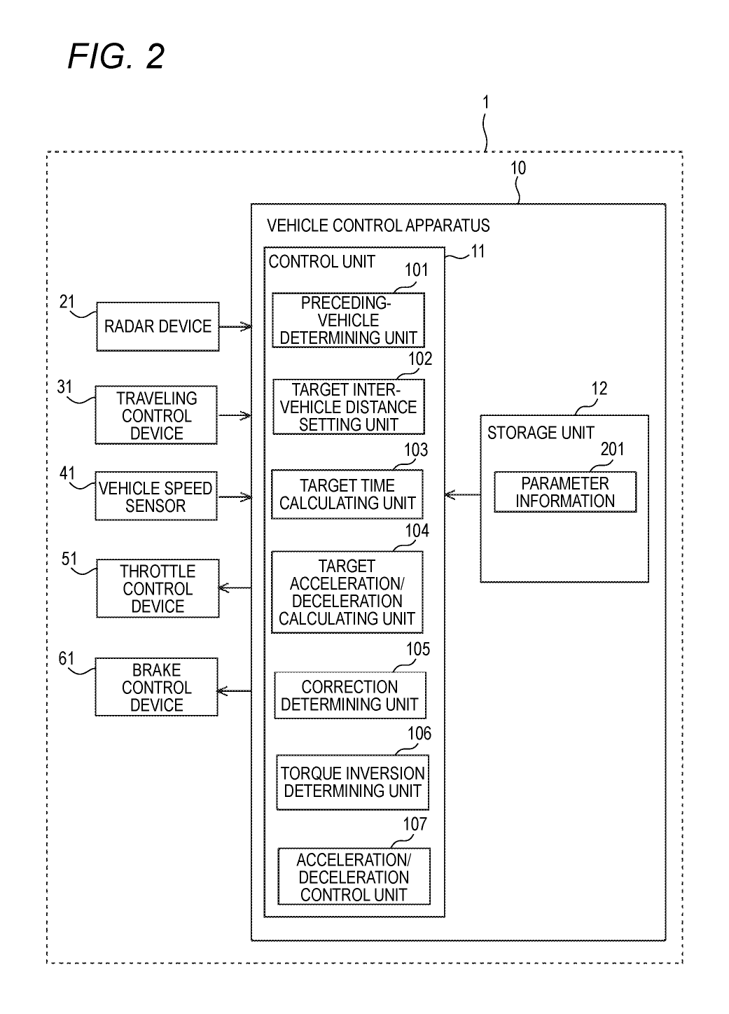

Now, the configuration of a vehicle control system of the present embodiment will be described. FIG. 2 is a view for explaining the configuration of a vehicle control system 1. The vehicle control system 1 mainly includes a vehicle control apparatus 10, a radar device 21, a traveling control device 31, a vehicle speed sensor 41, a throttle control device 51, and a brake control device 61.

The vehicle control apparatus 10 is installed in the vehicle CR, and acquires a variety of information to be used for vehicle control of the vehicle CR, from the radar device 21, the traveling control device 31, and the vehicle speed sensor 41. Further, on the basis of the variety of acquired information, the vehicle control apparatus 10 outputs a signal related to acceleration on the vehicle CR to the throttle control device 51 or outputs a signal related to deceleration on the vehicle CR to the brake control device 61, thereby controlling acceleration/deceleration on the vehicle CR.

The radar device 21 is installed in the vehicle CR, and detects targets existing around the vehicle CR. Specifically, the radar device 21 detects the actual inter-vehicle distance and relative speed Rv of the preceding vehicle FR traveling on a lane where the vehicle CR travels, and outputs information on them to the vehicle control apparatus 10.

The traveling control device 31 outputs engine torque information on the torque of the engine of the vehicle CR, and gear information on the current gear position of the vehicle CR, to the vehicle control apparatus 10.

The vehicle speed sensor 41 outputs the speed of the vehicle CR based on the number of revolutions of the axle of the vehicle CR, to the vehicle control apparatus 10.

The throttle control device 51 controls the opening the throttle of the engine on the basis of a signal related to acceleration and received from the vehicle control apparatus 10, thereby accelerating the vehicle CR.

The brake control device 61 puts a brake on the wheels of the vehicle CR on the basis of a signal related to deceleration and received from the vehicle control apparatus 10, thereby decelerating the vehicle CR.

Now, the configuration of the vehicle control apparatus 10 will be described. The vehicle control apparatus 10 mainly includes a control unit 11 and a storage unit 12.

The control unit 11 includes a micro computer including a CPU and the like, and performs general control on the vehicle control apparatus 10.

The storage unit 12 is composed of an erasable programmable read only memory (EPROM), a flash memory, or the like, and stores parameter information 201. The parameter information 201 is information usable for vehicle control of the vehicle CR, and is information on the maximum torque, the gear ratio, and so on. The maximum torque is the maximum value of the torque of the engine of the vehicle CR. Also, the gear ratio is the transmission gear ratio associated with information on the current gear position of the vehicle CR.

The control unit 11 mainly includes a preceding-vehicle determining unit 101, a target inter-vehicle distance setting unit 102, a target time calculating unit 103, a target acceleration/deceleration calculating unit 104, a correction determining unit 105, a torque inversion determining unit 106, and an acceleration/deceleration control unit 107.

### 3. Processes

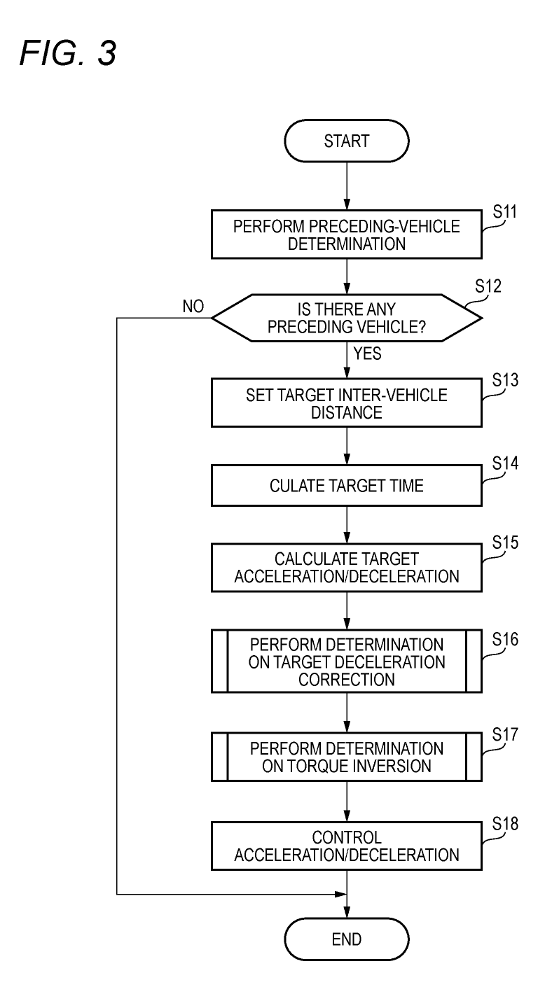

The processes of the individual units of the control unit 11 will be described with reference to the process flow chart of FIG. 3. FIG. 3 is a flow chart illustrating the processes of the control unit 11. These processes are repeated in a cycle (for example, 50 msec) in which the radar device 21 derives information on targets existing around the vehicle CR.

The preceding-vehicle determining unit 101 acquires information on the actual inter-vehicle distance and relative speed Rv of each target detected by the radar device 21.

Subsequently, in STEP S11, on the basis of the target information, the preceding-vehicle determining unit 101 determines whether any preceding vehicle FR to be followed has been detected. Specifically, on the basis of information on the actual inter-vehicle distance, relative speed, and angle of each target acquired from the radar device 21, the preceding-vehicle determining unit 101 determines whether there is any target traveling in the same direction as the traveling direction of the vehicle CR on the lane where the vehicle CR travels.

In a case where the preceding-vehicle determining unit 101 determines that there is a target of a preceding vehicle FR (“Yes” in STEP S12), in STEP S13, the target inter-vehicle distance setting unit 102 sets a target inter-vehicle distance Td between the vehicle CR and the preceding vehicle FR. In a case where a value has been set by an operation of the user of the vehicle CR as described above, the set value provides the target inter-vehicle distance Td. Alternatively, on the basis of the vehicle speed which the vehicle control apparatus 10 has acquired from the vehicle speed sensor 41, the target inter-vehicle distance setting unit 102 sets the target inter-vehicle distance Td.

Subsequently, in STEP S14, on the basis of the inter-vehicle distance deviation De and the relative speed Rv, the target time calculating unit 103 calculates a target time Tm required for the inter-vehicle distance deviation of 0 m and required for the relative speed of 0 m/s. For example, the target time calculating unit 103 calculates the target time Tm by a known method using a Gauss function having the inter-vehicle distance deviation De and the relative speed Rv as parameters.

Subsequently, in STEP S15, the target acceleration/deceleration calculating unit 104 calculates a target acceleration/deceleration Mv which is a target value of a acceleration/deceleration required for the inter-vehicle distance deviation of 0 m and required for the relative speed of 0 m/s. Here, on the assumption that the preceding vehicle FR is moving at a constant speed, the target acceleration/deceleration Mv can be obtained by Expression 1.

$$Mv = \frac{2 \times ( Rv + Td + De )}{{Tm}^{2}} \qquad [ Expression 1 ]$$

Also, in order to mainly describe a deceleration below, on the assumption that the target acceleration/deceleration Mv is a target deceleration Mv, the following description will be made.

<3-1. Determination on Target Deceleration Correction>

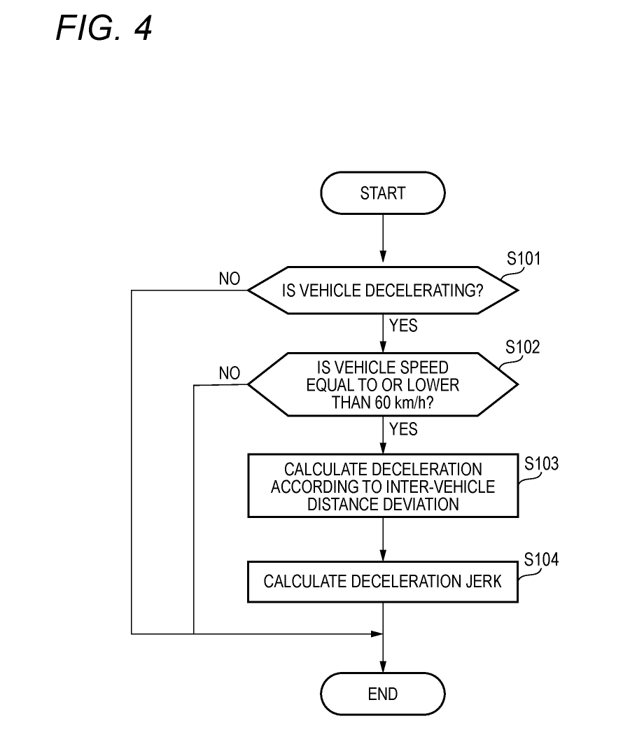

Subsequently, the correction determining unit 105 performs determination on correction of the target deceleration Mv. Now, determination on correction of the target deceleration Mv will be described in detail with reference to FIGS. 4 to 6. FIG. 4 is a flow chart illustrating a correction determination process. In STEP S101, on the basis of the vehicle speed acquired from the vehicle speed sensor 41, the correction determining unit 105 determines whether the vehicle CR is decelerating. In a case where the vehicle CR is decelerating (“Yes” in STEP S101), in STEP S102, the correction determining unit 105 determines whether the vehicle speed is equal to or lower than 60 km/h, or not.

In a case where the speed of the vehicle CR equal to or lower than 60 km/h (“Yes” in STEP S102), in STEP S103, the correction determining unit 105 calculates a correction deceleration MAv. The correction deceleration MAv is a deceleration which the correction determining unit 105 obtains by correcting the target deceleration according to the inter-vehicle distance deviation De, as will be described below. In the processes of STEPS S101 and S102 described above, it is determined that the vehicle CR continues to decelerate with respect to the preceding vehicle FR. Meanwhile, in a case where it is determined in the process of the STEP S101 that the vehicle CR is not decelerating (“No” in STEP S101), or in a case where it is determined in the process of STEP S102 that the vehicle speed exceeds 60 km/h (“No” in STEP S102), the target deceleration correction process finishes.

In a case where the inter-vehicle distance deviation De satisfies a condition (a1), the correction determining unit 105 calculates the correction deceleration MAv by Expression 2. Meanwhile, in a case where the inter-vehicle distance deviation De does not satisfy the condition (a1), that is, in a case where the inter-vehicle distance deviation satisfies a condition (a2), the correction determining unit 105 calculates the correction deceleration MAv by Expression 3.

(a1) De<−1 m

MAv−Mv×2 [Expression 2]

(a2) De≧−1 m

MAv−1×Mv+1 [Expression 3]

According to the condition (a1), in a case where the inter-vehicle distance deviation De at the proximity position P1 of the vehicle CR which is closer to the preceding vehicle FR than the reference position P0 where the inter-vehicle distance deviation De is substantially 0 m is less than −1 m, the correction determining unit 105 calculates a first correction deceleration MAv which is twice the target deceleration Mv, as a new target deceleration. In other words, in a case where the vehicle CR is relatively close to the preceding vehicle FR, the correction determining unit 105 calculates the first correction deceleration MAv significantly larger than the target deceleration Mv.

In contrast, according to the condition (a2), in a case where the inter-vehicle distance deviation De at a position of the vehicle CR which is closer to the preceding vehicle FR than the reference position P0 and is farther from the preceding vehicle FR than the proximity position P1 is equal to or larger than −1 m, the correction determining unit 105 calculates a second correction deceleration MAv which is smaller than the first correction deceleration MAv, as a new target deceleration. In other words, even though the vehicle CR is close to the preceding vehicle FR, if the inter-vehicle distance deviation is relatively small, the correction determining unit 105 calculates the second correction deceleration MAv which is slightly larger than the target deceleration Mv.

As described above, in the case where the inter-vehicle distance deviation De of the vehicle CR and the preceding vehicle FR satisfies the condition (a1), the correction determining unit 105 determines that a risk that the vehicle CR would collide with the preceding vehicle FR is relatively high, and performs correction to significantly increase the target deceleration Mv. Meanwhile, in the case where the inter-vehicle distance deviation De satisfies the condition (a2), the correction determining unit 105 determines that a risk that the vehicle CR would collide with the preceding vehicle FR is relatively low, and performs correction to slightly increase the target deceleration Mv. As described above, the correction determining unit 105 sets a correction amount of the target deceleration Mv according to the risk of collision of the vehicle CR with the preceding vehicle FR, and calculates the correction deceleration MAv.

Subsequently, in STEP S104, the correction determining unit 105 calculates a deceleration jerk Jv according to the correction deceleration MAv and the target time. The deceleration jerk Jv is a value which is obtained by differentiating the deceleration with respect to time, and is a value representing the amount of variation of the deceleration at each time. Specifically, the correction determining unit 105 calculates a deceleration jerk Jv corresponding to the correction deceleration MAv, on the basis of conditions (b1) to (b3).

(b1) −1 m/s²<MAv≦0 m/s²

(b2) −2 m/s²<MAv≦−1 m/s²

(b3) MAv≦−2 m/s²

In a case where the correction deceleration MAv satisfies the condition (b1), the correction determining unit 105 calculates a deceleration jerk Jv such that the minimum value of the deceleration jerk is −0.7 m/s³. According to the condition (b1), in a case where the correction deceleration MAv is relatively small, the deceleration jerk Jv also provides a relatively small value. In other words, the deceleration jerk Jv provides a value equal to or larger than −0.7 m/s³, and does not provide a value (for example, −0.8 m/s³) smaller than −0.7 m/s³.

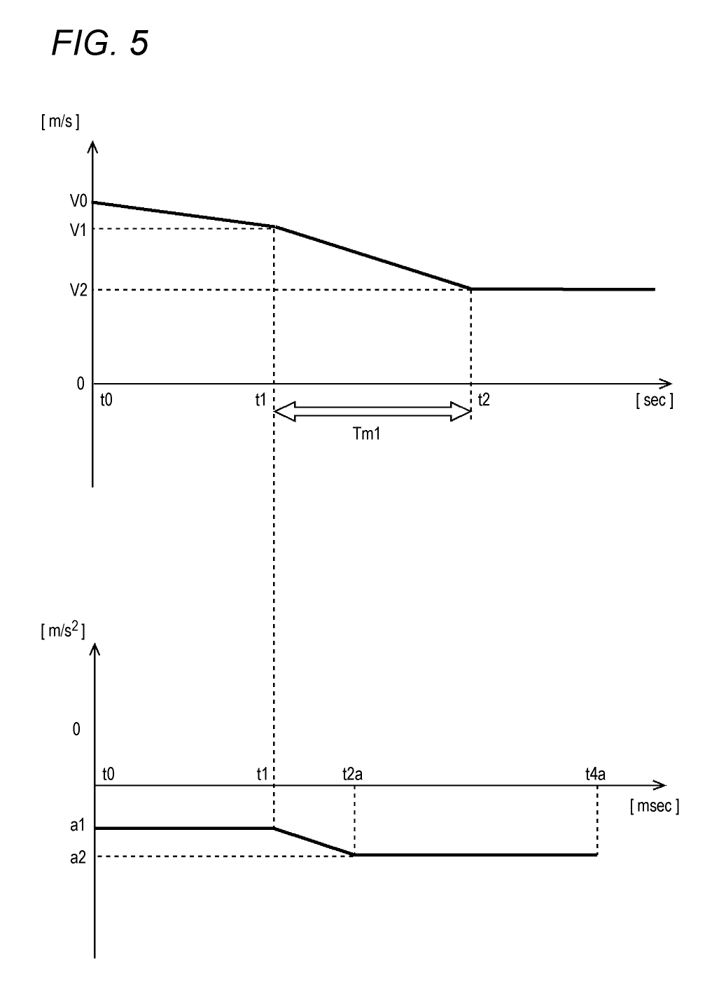

This will be now described in detail with reference to FIG. 5. FIG. 5 is a view illustrating transitions of the speed and deceleration of the vehicle CR over time. In a graph shown in the upper part of FIG. 5 and representing the speed of the vehicle CR, the horizontal axis and the vertical axis represent time (sec) and speed (m/s), respectively. Also, in a graph shown in the lower part of FIG. 5 and representing the deceleration, the horizontal axis and the vertical axis represent time (sec) and deceleration (m/s²), respectively. Here, on the assumption that the vehicle CR travels at a vehicle speed exceeding 60 km/h from a time t0 before a time t1 and travels at a vehicle speed equal to or lower than 60 km/h at the time t1, a description will be made. Also, the variation of the deceleration shown between the time t0 and a time t4a in the deceleration graph of the lower part of FIG. 5 corresponds to the variation of the speed for a short time around the time t1 in the speed graph of the upper part of FIG. 5.

At the time t0 of FIG. 5, the speed of the vehicle CR provides V0 (V0>60 km/h), and the deceleration provides a1. Also, between the time t0 and the time t1, the vehicle CR continues to decelerate at a deceleration a1, whereby the speed decreases from a speed V0 to a speed V1 (V0>V1 and V1≦60 km/h). Further, a time t2 is a target time Tm1 which is required at the time t1, and when the time t2 comes, the inter-vehicle distance deviation De of the vehicle CR and the preceding vehicle FR is substantially 0 and the relative speed is substantially 0 m/s.

Also, if the vehicle speed provides a value equal to or lower than 60 km/h at the time t1, the correction determining unit 105 changes the deceleration. In other words, between the time t1 and a time t2a, the correction determining unit 105 decreases the deceleration from a1 to a2 (a1>a2). As described above, the minimum value of the deceleration jerk Jv which is applied in a case where the deceleration satisfies the condition (b1) becomes −0.7 m/s³. In other words, on the basis of the correction deceleration MAv calculated at the time t1, the correction determining unit 105 calculates the deceleration jerk Jv corresponding to the slope of the line representing the deceleration and shown in the lower part of FIG. 5 (hereinafter, referred to as the “deceleration line”) within the minimum value range.

A first slope which is the slope of the deceleration line of the lower part of FIG. 5 is steeper than the slope of the deceleration line before the time t1, but is gentler than the slope of the deceleration line under the conditions (b2) and (b3) to be described below. Therefore, the vehicle control apparatus 10 can perform control such that the vehicle CR decelerates appropriately while preventing occurrence of factors such as swing back which inhibit the comfort of the user of the vehicle CR.

In a case where the correction deceleration MAv satisfies the condition (b2), the correction determining unit 105 calculates a deceleration jerk Jv such that the minimum value of the deceleration jerk becomes −2.0 m/s³. According to the condition (b2), in a case where the correction deceleration MAv is relatively large, the deceleration jerk Jv also provides a relatively large value. In other words, the deceleration jerk Jv provides a value equal to or larger than −2.0 m/s³, and does not provide a value (for example, −2.1 m/s³) smaller than −2.0 m/s³.

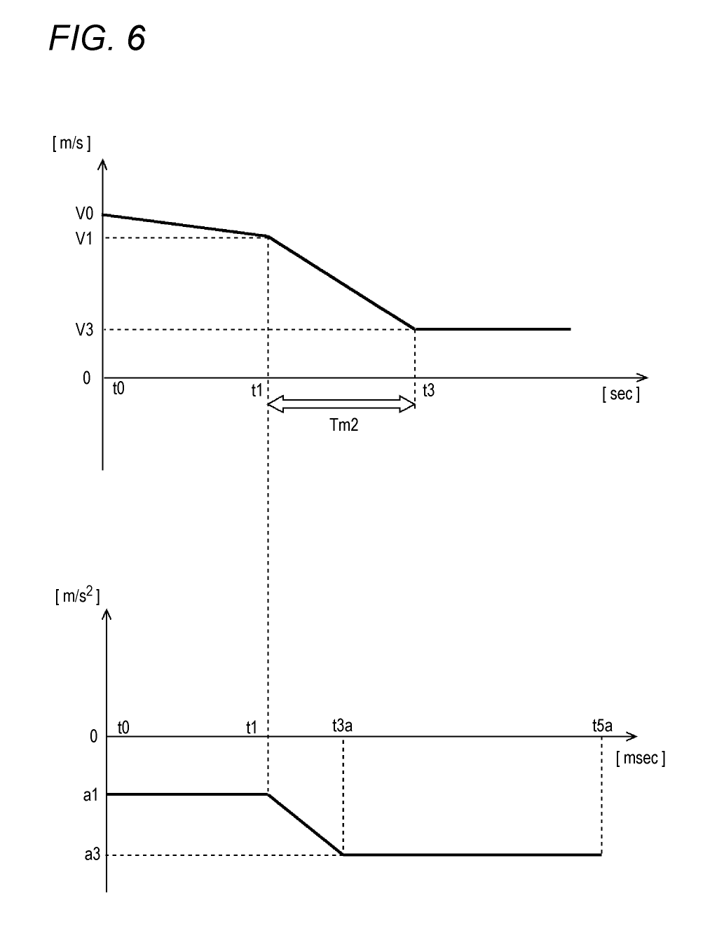

This will be now described in detail with reference to FIG. 6. FIG. 6 is a view illustrating transitions of the speed and deceleration of the vehicle CR over time. The increase in the value of the deceleration shown in FIG. 6 is larger than that of the deceleration of FIG. 5 described above. In a graph shown in the upper part of FIG. 6 and representing the speed of the vehicle CR, the horizontal axis and the vertical axis represent time (sec) and speed (m/s), respectively. Also, in a graph shown in the lower part of FIG. 6 and representing the deceleration of the vehicle CR, the horizontal axis and the vertical axis represent time (sec) and deceleration (m/s²), respectively. Here, on the assumption that the vehicle CR travels at a vehicle speed exceeding 60 km/h from a time t0 before a time t1 and travels at a vehicle speed equal to or lower than 60 km/h at the time t1, a description will be made. Also, the variation of the deceleration shown between the time t0 and a time t5a in the deceleration graph of the lower part of FIG. 6 corresponds to the variation of the speed for a short time around the time t1 in the speed graph of the upper part of FIG. 6.

At the time t0 of FIG. 6, the speed of the vehicle CR provides V0 (V0>60 km/h), and the deceleration provides a1. Also, between the time t0 and the time t1, the vehicle CR continues to decelerate at a deceleration a1, whereby the speed decreases from a speed V0 to a speed V1 (V0>V1 and V1≦60 km/h). Further, a time t3 is a target time Tm2 which is required at the time t1, and when the time t3 comes, the inter-vehicle distance deviation De of the vehicle CR and the preceding vehicle FR is substantially 0 and the relative speed is substantially 0 m/s. The target time Tm2 is shorter than the target time Tm1 described above.

Also, if the vehicle speed provides a value equal to or lower than 60 km/h at the time t1, the correction determining unit 105 changes the deceleration. In other words, between the time t1 and a time t3a, the correction determining unit 105 decreases the deceleration from a1 to a3 (a1>a3). As described above, the minimum value of the deceleration jerk Jv which is applied in a case where the deceleration satisfies the condition (b1) becomes −2.0 m/s³. In other words, on the basis of the increased deceleration value at the time t1, the correction determining unit 105 calculates the deceleration jerk Jv corresponding to the slope of the deceleration line within the minimum value range. Also, as compared to the first slope of the deceleration line in the case where the condition (b1) is satisfied, a second slope of the deceleration line in the case where the condition (b2) is satisfied is a large negative slope. Therefore, even in a case where the deceleration is relatively large, the vehicle control apparatus 10 can perform control such that the vehicle decelerates appropriately while preventing occurrence of factors such as swing back which inhibit the comfort of the user of the vehicle, as much as possible.

Further, in a case where the correction deceleration MAv satisfies the condition (b3), the correction determining unit 105 calculates a deceleration jerk Jv larger than the deceleration jerk Jv based on the condition (b2). According to this condition (b3), in a case where the correction deceleration MAv is larger than the deceleration under the condition (b2), the minimum value of the deceleration jerk Jv is not limited to a specific value. In other words, the slope of the deceleration line in the case where the condition (b3) is satisfied becomes a third slope steeper than the second slope.

In this case where the condition (b3) is satisfied, in order to avoid collision with the preceding vehicle FR, the vehicle CR needs a very large deceleration. Therefore, in order to ensure the safety of the user of the vehicle CR, the vehicle control apparatus 10 prioritizes stopping of the vehicle CR even if a load such as swing back on the user occurs.

As described above, the vehicle control apparatus 10 controls the deceleration of the vehicle CR at the deceleration jerk Jv based on the correction deceleration MAv such that the inter-vehicle distance deviation De is substantially 0 m and the relative speed is substantially 0 m/s. Therefore, it is possible to ensure the safety of the user of the vehicle CR and implement appropriate vehicle control on the vehicle CR.

<3-2. Determination on Torque Inversion>

Subsequently, the torque inversion determining unit 106 performs determination on inversion of the driving torque and braking torque of the vehicle CR. The reason why this determination is performed is as follows. In a case where the vehicle control apparatus 10 decelerates the vehicle CR, with the decrease in the vehicle speed, the vehicle CR shifts into low gear. Further, according to this shift into low gear, the driving torque increases. The driving torque is torque to drive the vehicle CR in the traveling direction. Also, with the decease in the speed of the vehicle CR, the braking torque decreases. The braking torque is torque to brake the vehicle CR.

As a result, when the vehicle CR reaches the reference position P0, the magnitude of the driving torque may exceed the magnitude of the braking torque, whereby the vehicle CR may stop within a distance shorter than the target inter-vehicle distance. In this case, the user of the vehicle CR feels a risk of collision of the vehicle CR with the preceding vehicle FR, and the safety of the user of the vehicle CR is hindered.

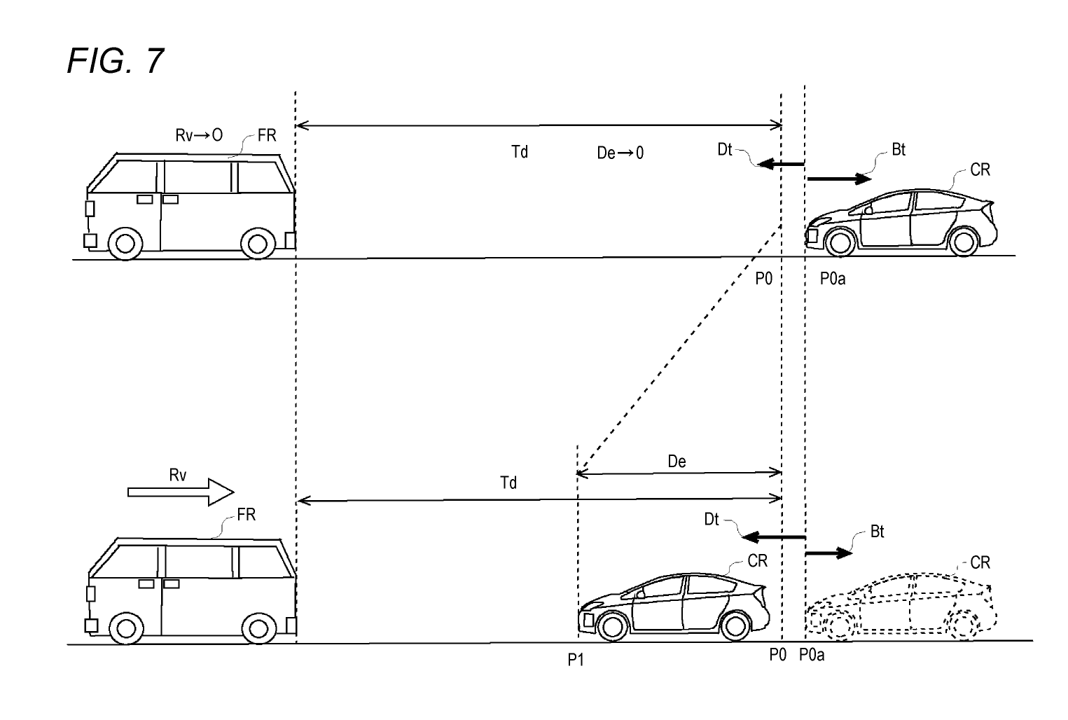

Now, the relation between the driving torque Dt and braking torque Bt of the vehicle CR immediately before stopping will be described. FIG. 7 is a view for explaining the relation between the driving torque Dt and braking torque Bt of the vehicle CR immediately before stopping. FIG. 7 is substantially the same as FIG. 1 described above. However, FIG. 7 is different from FIG. 1 in that it shows the driving torque Dt and the braking torque Bt. Specifically, FIG. 7 shows the driving torque Dt and braking torque Bt of a reference front-side position P0a and the driving torque Dt and braking torque Bt of a proximity front-side position P1a. The reference front-side position P0a is the position of the vehicle CR relative to the reference position P0 immediately before stopping. The proximity front-side position P1a is the position of the vehicle CR relative to the proximity position P1 immediately before stopping.

First, the lower part of FIG. 7 will be described. In a case where the vehicle CR automatically stops without any operation of a driver, at the proximity front-side position P1a immediately before stopping, the driving torque Dt according to creeping exceeds the braking torque Bt. As a result, the vehicle CR passes the reference position P0 and stops at the proximity position P1, and the user of the vehicle CR feels a risk of collision with the preceding vehicle FR. For this reason, the torque inversion determining unit 106 performs determination on torque inversion (to be described below), and calculates a deceleration according to the determination result. As a result, as shown in the upper part of FIG. 7, at the reference front-side position P0a, the braking torque Bt exceeds the driving torque Dt. Therefore, the vehicle CR can stop at the reference position P0 where the inter-vehicle distance deviation is substantially 0 m.

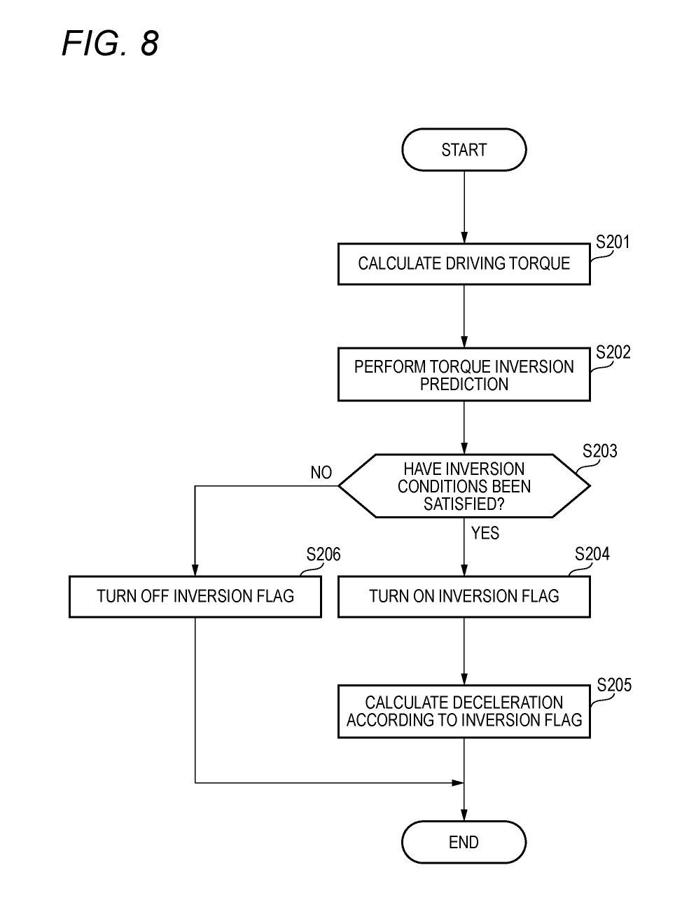

Hereinafter, a process of performing determination on torque inversion will be described. In the processes of FIG. 3, in STEP S17, the torque inversion determining unit 106 performs the process of performing determination on torque inversion. This process of performing determination on torque inversion will be described in detail with reference to FIG. 8. FIG. 8 is a flow chart illustrating a torque determination process.

In STEP S201, the torque inversion determining unit 106 calculates the driving torque Dt of the vehicle CR by Expression 4. In other words, the torque inversion determining unit 106 calculates the driving torque Dt (Nm), using the maximum torque Mt (Nm) of the parameter information 201, a gear ratio Gr, and engine torque Et (%). Also, the engine torque Et is calculated on the basis of the engine torque information acquired from the traveling control device 31. Also, the gear ratio Gr is calculated on the basis of the gear information acquired from the traveling control device 31.

Dt=Mt×Et×0.01×Gr [Expression 4]

In STEP S202, the torque inversion determining unit 106 determines whether a possibility that the driving torque Dt and the braking torque Bt would be inverted is relatively high, by predetermined conditions. In other words, the torque inversion determining unit 106 determines whether the possibility that the magnitude of the driving torque Dt would exceed the magnitude of the braking torque Bt is relatively high, by the following conditions (c1) to (c3).

(c1) The gear is in second.

(c2) −1 [m/s²]<Mv<0 [m/s²]

(c3) Dt>250 [Nm]

Here, the target deceleration Mv of the condition (c2) corresponds to the correction deceleration MAv in a case where the correction deceleration MAv has been calculated in the determination process of STEP S16 on target deceleration correction, and corresponds to the uncorrected target deceleration Mv in a case where the correction deceleration MAv has not been calculated.

According to the conditions (c1) and (c2), whether the vehicle CR traveling along the preceding vehicle FR is about to stop. Also, according to the condition (c3), the magnitude of the driving torque is determined.

In a case where all of the conditions (c1) to (c3) are satisfied (“Yes” in STEP S203), in STEP S204, the torque inversion determining unit 106 turns on a torque inversion flag of control data on acceleration and deceleration of the vehicle CR. Meanwhile, in a case where any one of the conditions (c1) to (c3) is not satisfied (“No” in STEP S203), the torque inversion determining unit 106 turns off the torque inversion flag of the control data. In a case where the torque inversion flag of the control data is already in an OFF state, the torque inversion determining unit keeps the OFF state.

Control data in which the torque inversion flag is in an ON state is data representing that, in a case where the vehicle CR following the preceding vehicle FR automatically stops without any operation of the driver, a possibility that the driving torque Dt of the vehicle CR immediately before stopping would exceed the braking torque Bt is relatively high. Also, control data in which the torque inversion flag is in the OFF state is data representing that, in a case where the vehicle CR following the preceding vehicle FR automatically stops without any operation of the driver, a possibility that the driving torque Dt of the vehicle CR immediately before stopping would exceed the braking torque Bt is relatively low.

In STEP S205, the torque inversion determining unit 106 calculates an update deceleration MRv, as a new target deceleration, according to whether the torque inversion flag is in the ON state or the OFF state. Specifically, in a case where the torque inversion flag of the control data is in the ON state, the torque inversion determining unit 106 calculates the update deceleration MRv by Expression 5.

MRv=Mv−(Dt−250)×0.001 [Expression 5]

Referring to FIG. 3 again, in STEP S18, the acceleration/deceleration control unit 107 controls the acceleration/deceleration of the vehicle CR on the basis of the update deceleration MRv.

As described above, the vehicle control apparatus 10 calculates the update deceleration MRv, and decelerates the vehicle such that the magnitude of the braking torque exceeds the magnitude of the driving torque, thereby capable of automatically stopping the vehicle CR, without any operation of the driver, in a state where the inter-vehicle distance deviation De from the target inter-vehicle distance Td between the vehicle and the preceding vehicle FR is substantially 0 m. Therefore, there is no possibility that the user of the vehicle CR would feel a risk of collision with the preceding vehicle FR, and it is possible to ensure the safety of the user of the vehicle CR.

Meanwhile, in a case where the torque inversion flag is in the OFF state, the torque inversion determining unit 106 controls the deceleration of the vehicle CR, using the target deceleration Mv. Even in this case, the vehicle control apparatus 10 can stop the vehicle CR in a state where the inter-vehicle distance deviation is substantially 0 m, and can surely ensure the safety of the user of the vehicle CR.

### Modifications

Although the embodiments of the present invention have been described above, the present invention is not limited to the above described embodiments, and can be modified in various forms. Hereinafter, these modifications will be described. All forms including the above described embodiments and the following embodiments to be described below can be appropriately combined.

In the above described embodiment, the driving torque Dt of the vehicle CR is calculated by Expression 4, and the update deceleration MRv is calculated by Expression 5, and the vehicle CR is controlled such that the braking torque Bt exceeds the driving torque Dt immediately before the vehicle CR stops. In contrast, the acceleration/deceleration control unit 107 may store the maximum value of the driving torque Dt of the vehicle CR immediately before stopping, in the storage unit 12, in advance, and calculate an update deceleration providing the braking torque Bt exceeding the maximum value of the driving torque Dt immediately before stopping, and control the vehicle CR on the basis of the calculated update deceleration. In this case, the vehicle control apparatus 10 can reduce the process of calculating the driving torque Dt, and can reduce a processing load.

Also, in the above described embodiment, in order to detect the actual inter-vehicle distance and relative speed Rv between the vehicle CR and the preceding vehicle FR, the radar device 21 is used. In contrast, any device other than the radar device 21 may be used as long as it can detect the actual inter-vehicle distance and the relative speed Rv. For example, a camera may be used to take images and detect the actual inter-vehicle distance and the relative speed Rv on the basis of information on the images.

Also, in the above described embodiment, various functions are implemented in a software wise by arithmetic processing of the CPU according to programs. However, some of those functions may be implemented by electric hardware circuits. Also, conversely, some of functions which are implemented by hardware circuits may be implemented in a software wise.

What is claimed is:

1. A vehicle control apparatus for performing control such that a vehicle follows a preceding vehicle, comprising:
a calculating unit that calculates a target time for an inter-vehicle distance deviation which is obtained by subtracting a target inter-vehicle distance from a measurement value of the inter-vehicle distance between the vehicle and the preceding vehicle to be substantially 0;
a correction unit that calculates a correction deceleration larger than a target deceleration in a case where the inter-vehicle distance deviation provides a deviation corresponding to a position of the vehicle closer to the preceding vehicle than a position where the inter-vehicle distance deviation is substantially 0; and
a control unit that controls a deceleration of the vehicle at a deceleration jerk according to a magnitude of the correction deceleration such that, when the target time comes, the inter-vehicle distance deviation is substantially 0.

2. The vehicle control apparatus according to claim 1, wherein:
in a case where the inter-vehicle distance deviation provides a first deviation corresponding to the position of the vehicle closer to the preceding vehicle than the position where the inter-vehicle distance deviation is substantially 0, the correction unit calculates a first correction deceleration larger than the target deceleration, and
the control unit controls the deceleration of the vehicle at a deceleration jerk according to the first correction deceleration and larger than a deceleration jerk according to the target deceleration, such that, when the target time comes, the inter-vehicle distance deviation is substantially 0.

3. The vehicle control apparatus according to claim 2, wherein:
in a case where the inter-vehicle distance deviation provides a second deviation corresponding to the position of the vehicle closer to the preceding vehicle than the position where the inter-vehicle distance deviation is substantially 0 and corresponding to a position of the vehicle farther from the preceding vehicle than a position where the first deviation is obtained, the correction unit calculates a second correction deceleration smaller than the first correction deceleration, and
the control unit controls the deceleration of the vehicle at a deceleration jerk according to the second correction deceleration and smaller than the deceleration jerk according to the first target deceleration, such that, when the target time comes, the inter-vehicle distance deviation is substantially 0.

4. The vehicle control apparatus according to claim 1, further comprising:
an acquiring unit that acquires information on a driving torque to drive the vehicle in a traveling direction,
wherein the control unit controls the deceleration of the vehicle such that, in a case where the vehicle automatically stops without any operation of a driver, braking torque to brake the vehicle exceeds the driving torque.

5. The vehicle control apparatus according to claim 1, further comprising:
a storage unit that stores a driving torque of the vehicle immediately before stopping,
wherein the control unit controls the deceleration of the vehicle such that, in a case where the vehicle automatically stops without any operation of a driver, braking torque to decelerate the vehicle exceeds the driving torque of the vehicle immediately before stopping.

6. A vehicle control system comprising:
a radar device that detects target information on a position of a preceding vehicle and relative speed to the preceding vehicle; and
a vehicle control apparatus including:
a calculating unit that calculates a target time for an inter-vehicle distance deviation which is obtained by subtracting a target inter-vehicle distance from a measurement value of the inter-vehicle distance between the vehicle and the preceding vehicle to be substantially 0;
a correction unit that calculates a correction deceleration larger than a target deceleration in a case where the inter-vehicle distance deviation provides a deviation corresponding to a position of the vehicle closer to the preceding vehicle than a position where the inter-vehicle distance deviation is substantially 0; and
a control unit that controls the deceleration of the vehicle at a deceleration jerk according to the magnitude of the correction deceleration such that, when the target time comes, the inter-vehicle distance deviation is substantially 0.

7. A vehicle control method of performing control such that a vehicle follows a preceding vehicle, comprising:
calculating a target time for an inter-vehicle distance deviation which is obtained by subtracting a target inter-vehicle distance from a measurement value of the inter-vehicle distance between the vehicle and the preceding vehicle to be substantially 0;
calculating a correction deceleration larger than a target deceleration in a case where the inter-vehicle distance deviation provides a deviation corresponding to a position of the vehicle closer to the preceding vehicle than a position where the inter-vehicle distance deviation is substantially 0; and
controlling the deceleration of the vehicle at a deceleration jerk according to the magnitude of the correction deceleration such that, when the target time comes, the inter-vehicle distance deviation is substantially 0.

8. A vehicle control apparatus for performing control such that a vehicle follows a preceding vehicle, comprising:
an acquiring unit that acquires information on a driving torque to drive the vehicle in a traveling direction; and
a control unit that controls the deceleration of the vehicle such that, in a case where the vehicle automatically stops without any operation of a driver of the vehicle, braking torque to brake the vehicle exceeds the driving torque.
